(19) United States
(12) Patent Application Publication
(10) Pub. No.: US 2017/0096051 A1
(43) Pub. Date: Apr. 6, 2017

(54) JEEP ACCESSORY

(71) Applicant: Floyd Gibbs, Newport News, VA (US)

(72) Inventor: Floyd Gibbs, Newport News, VA (US)

(21) Appl. No.: 14/872,781

(22) Filed: Oct. 1, 2015

(51) Int. Cl. B60J 1/20; B60J 5/04; B60N 3/10

(52) U.S. Cl. CPC B60J 1/2002; B60N 3/103; B60J 5/0487

(57) ABSTRACT

A water, wind, and debris-deflector designed for use with vehicles having removable doors. The deflector has a bracket assembly with a vertical structure to which the deflector is attached. The bracket assembly has horizontal structures allowing the invention to be attached to existing door hinges with hinge pins. The vertical structure further includes a mounting bar to which accessories such as drink holders and the like may be attached. The deflector is formed from material suited to deflecting water, wind, and debris at highway speeds. The deflector may be transparent.

### FIELD OF THE INVENTION

The invention described herein relates to automotive accessories. In particular, the invention relates to accessories that may be used with Jeep and jeep-like vehicles that are operated with the doors removed. More particularly, the present invention relates to water, wind and debris deflectors utilized to keep the operator and passengers of a vehicle safe and dry while the vehicle is being operated with the doors removed.

### BACKGROUND OF THE INVENTION

Jeeps and Jeep-brand vehicles have a long history and a strong following by people who like the particular style and capabilities of the vehicles. There is also a large desire and a strong market for jeep accessories, especially those geared towards enthusiasts who wish to add to the comfort and use of a jeep without compromising the nature of the jeep experience. Part of the enthusiasm for jeep use comes with the ability to remove portions of the vehicle, including the top, windows, and doors.

Part of the attraction of jeeps, besides being able to remove the top and doors, is that jeeps are generally very simple vehicles. They historically don't have many creature comforts built in, leaving room for the owner to modify the vehicle as they see fit. One problem with removing the doors from jeeps is that it leaves the driver and passenger exposed to water, mud, and other debris thrown up by the front wheels of the jeep as it is being driven. In addition, the removal of the doors and the simplistic nature of jeeps means that there are very few creature comforts included in the design or places to install or mount cup holders and the like.

It would therefore be advantageous to have a device that would be easily attachable to the side of a jeep once the doors are removed. It would be of further use if such a device provided for a structure to allow the mounting of cup holders or other creature comforts to the device.

### SUMMARY OF THE INVENTION

The present invention is related to vehicle accessories and wind/water deflectors designed for use with jeeps and other vehicles that can be operated without doors for the driver and passenger(s). In one aspect, the present invention is directed to a detachable structure that is affixed to a vehicle with the doors removed and provides a wind/water/mud/debris deflector. In another aspect, the invention provides a mounting structure to which is attached

It is therefore an object of the present invention to provide a device for vehicles that serves s a wind, water, mud and debris deflector.

It is a further object of the present invention to provide a device for vehicles that serves as a wind, water, mud and debris deflector and further provides a structure for the attachment of accessories.

### BRIEF DESCRIPTION OF THE DRAWINGS

These and other embodiments are described by the following figures and detailed description.

FIG. 1 is a view of an embodiment of the present invention.

FIG. 2 is a side view of the present invention in accordance with an embodiment of the present invention.

FIG. 3 is a back view of an embodiment of the present invention.

FIG. 4 is a top-down view of an embodiment of the present invention.

### DETAILED DESCRIPTION OF THE INVENTION

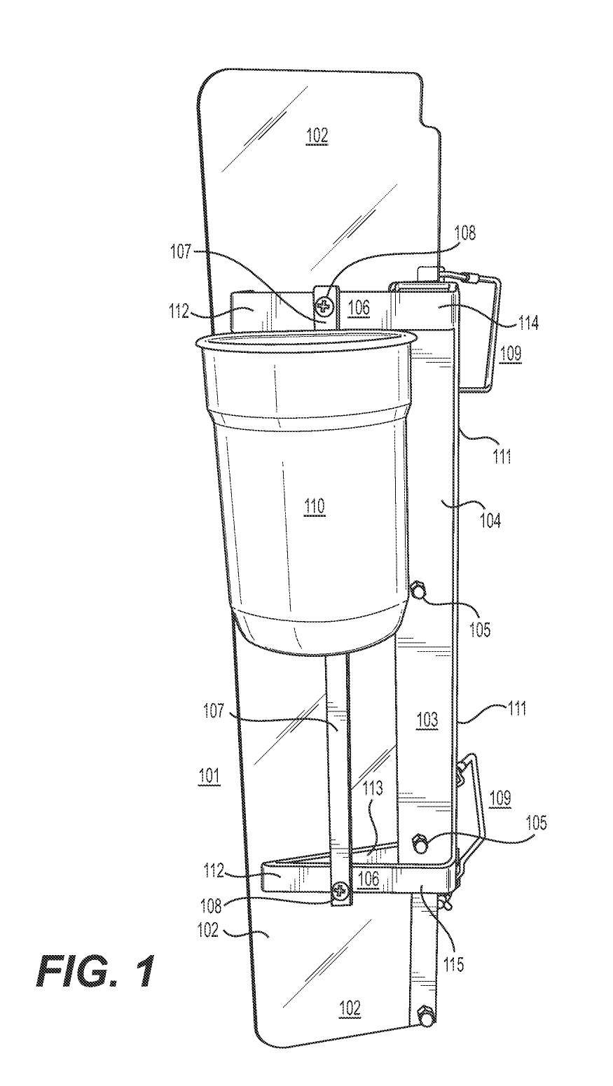

Referring now to FIG. 1, an embodiment of the present invention 101 is shown. A deflector 102 is mounted to a bracket assembly 103. The deflector may be constructed of various materials that are suitable for deflecting wind, water, and small road hazards such as rocks and the like. In a preferred embodiment, the deflector 102 is constructed of a clear Plexiglas or similar resilient material that is also transparent or semi-transparent. The bracket assembly 103 comprises a vertical portion 104 that is connected to the deflector 102 using bolts 105 or other equivalent and well known means. The vertical portion 104 is “L” shaped, with one or more support members 106 that form generally triangular structural elements, with a front portion 112 and a back portion 113, the front portion 112 extending between the outer edge 111 of the vertical portion 104 and the back portion 113, forming a generally flattened triangular shape. The front portion 112 and the back portion 113 may be formed from the same contiguous sheet of metal as the vertical portion, or they may be fabricated separately and joined by well-known metal joining techniques such as welding, mechanical fasteners, or the like. The device 101 as shown has the front portion 112 and the back portion 113 welded to the vertical portion 104, but it will be understood that the vertical portion 104 and the support members 106 may be fabricated by any well-known metal fabricating methods, and that the fabrication methods may change to accommodate the device being constructed from different materials. Any number of suitable materials might be utilized, such as carbon fiber, plastics, wood, etc., without deviating from the scope and intent of the invention.

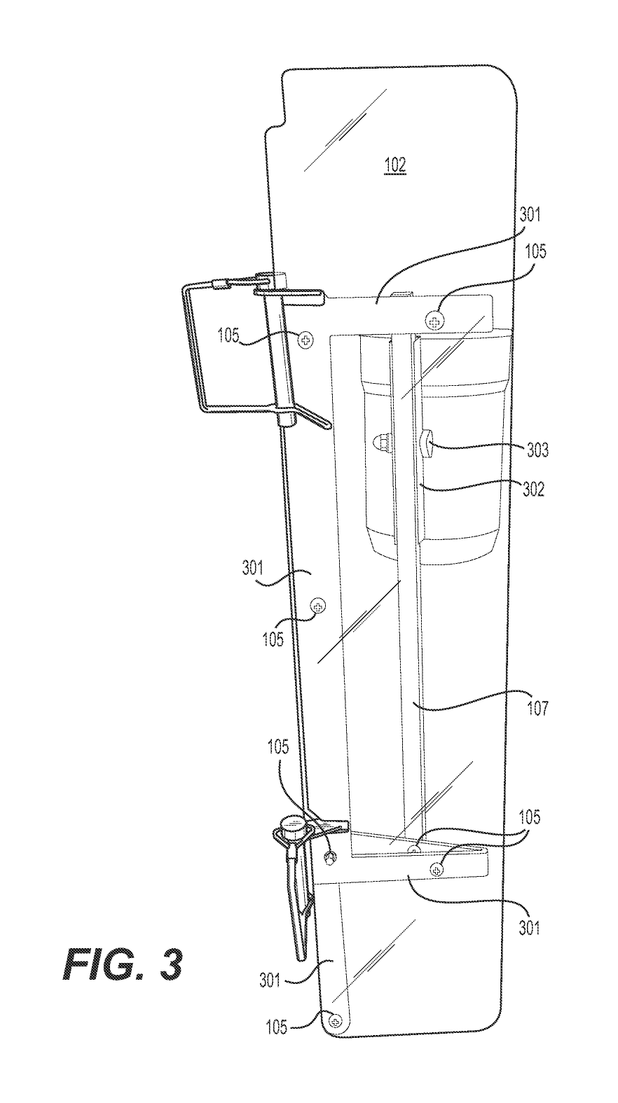

The back portion 113 forms a continuous flat surface (FIG. 3, 301) with the vertical portion 104. As shown the device 101 has a top support member 114 and a bottom support member 115. It will be understood that one or more support members 106 may be utilized, and the top support member 114 and the bottom support member 115 are shown as an illustrative embodiment. The deflector 102 is mounted against the flat surface (FIG. 3, 301) and is affixed to the bracket assembly 103 with bolts 105. The bracket assembly 103 extends below the vertical portion 104, providing stability to the lower portion of the deflector 102. The device as shown has the vertical portion 104 affixed to the deflector 102 with six bolts 105 (three are visible in FIG. 1; all six are shown in FIG. 3, 105).

The bracket assembly 103 further comprises a mounting bar 107. The mounting bar 107 is mechanically attached to the front portions 112 of the support members 106. The mounting bar 107 is utilized for attaching accessories. In the present example, cupholder 110 is shown attached to the mounting bar 107. In the invention as shown, the cupholder 110 is attached to the mounting bar 107 via a bracket (FIG. 3, 302) affixed to the cupholder 110, and affixed to the mounting bar 107 via a bolt (FIG. 3, 303). The mounting bar 107 may be configured or constructed to accept a variety of attachment means, including having bolt-holes at intervals, or other means such as clamps, permanent or semi-permanent attachment means.

The bracket assembly 103 further comprises one or more hinge pins 109. The hinge pins are designed to affix the bracket assembly 103 to the hinges (not shown) of the vehicle on which the user intends to use the device. The invention as shown utilizes two coupler lock pins as the hinge pins 109. The hinge pins 109 are illustrative of a preferred embodiment, and should not be understood to be limiting. Any attachment means may be utilized that is appropriate to secure the device to the door frame and/or hinges of a vehicle for use, and the adaptations for particular vehicles are anticipated as part of the invention.

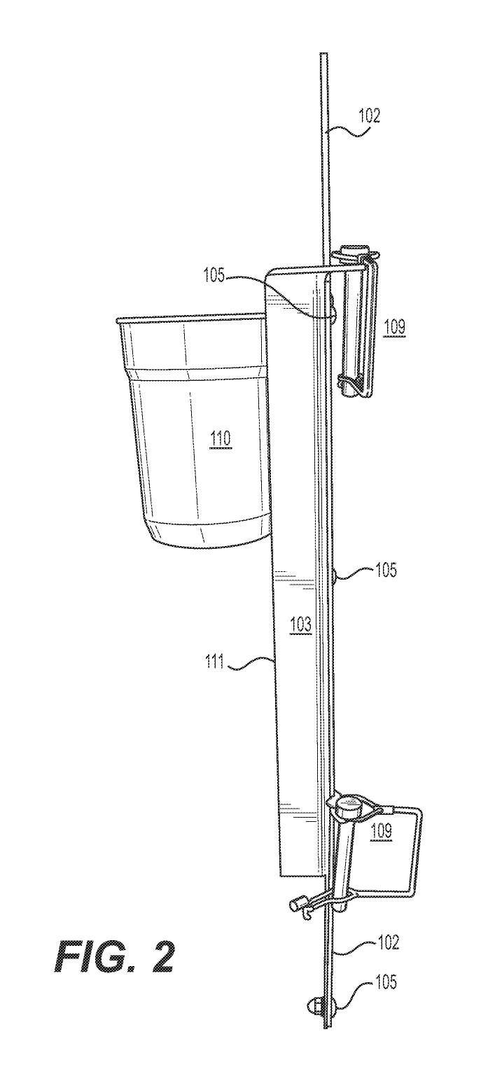

In FIG. 2, a side view of an embodiment of the present invention is shown.

FIG. 3 shows a rear view of an embodiment of the present invention. The elements as described above and shown in FIGS. 1 and 2 are readily shown. The wind deflector 101 further comprises a continuous flat surface 301, which provides structural stability to the present invention. This Figure shows a transparent deflector 102. Although it is advantageous to utilize a transparent deflector 102, it will be understood that various materials may be used to achieve the same purpose, even if the material chosen for the deflector 102 are opaque or partially opaque. It is advantageous, however, to use transparent material for the deflector 102 as it reduces the possible obstruction to the operator's view of the road, which can be especially important when operating off-road.

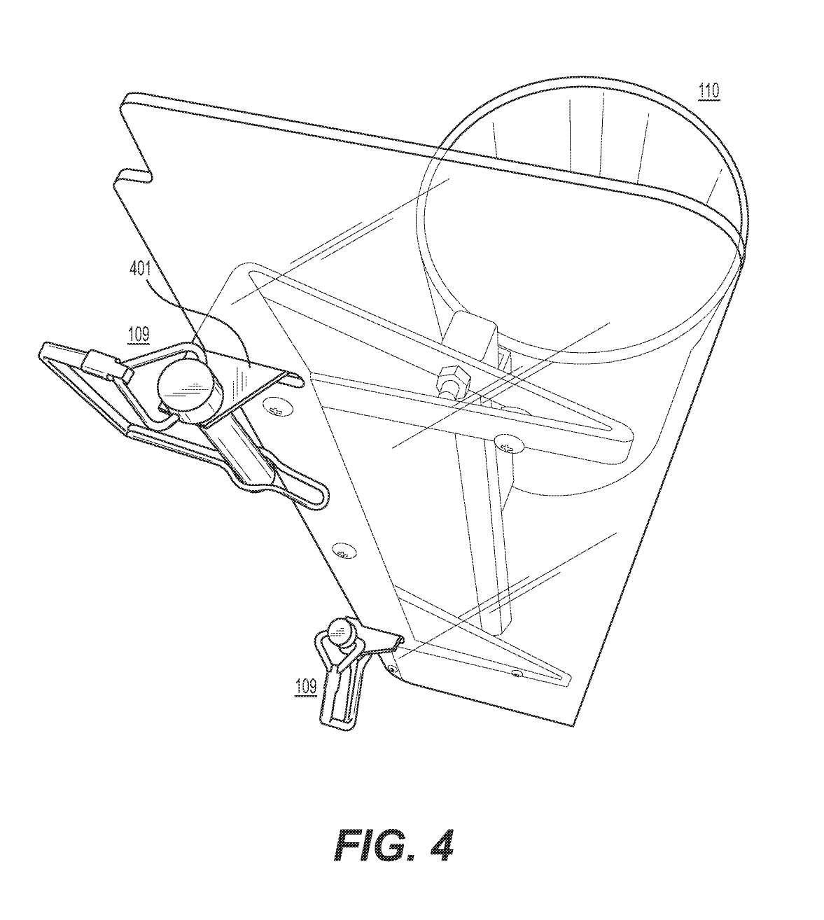

FIG. 4 shows a top-down view of the present invention. It will be understood from this Figure that the hinge pins 109 are disposed within horizontal extensions 401 of the bracket assembly 103. The horizontal extensions 401 have holes of sufficient diameter to accommodate the hinge pins 109. In FIG. 4, the view of the holes is obstructed by the hinge pins 109, but those skilled in the art will understand from this description and the accompanying Figures how the holes in the horizontal extensions 401 are disposed.

This invention has been described in sufficient detail to enable those skilled in the art to practice them, and it is to be understood that changes may be made without deviating from the scope of the invention described herein.

1. A. vehicle deflector comprising:
A bracket assembly, the bracket assembly having a vertical portion, two or more support members, and two or more horizontal portions;
A deflector attached to the vertical portion of the bracket assembly;
The deflector constructed of material chosen from the group of materials giving protection against water, wind, and debris at highway driving speeds; and
One or more hinge pins disposed within the two or more horizontal portions.

2. The vehicle deflector of claim 1 wherein the bracket assembly further comprises a mounting bar, the mounting bar affixed vertically to the two or more support members.

3. The vehicle deflector of claim 2 wherein the mounting bar further comprises one or more mounting means.

4. The vehicle deflector of claim 3 wherein the one or more mounting means is chosen from the group comprising having bolt-holes at intervals, clamps, permanent or semi-permanent attachment means.

5. The vehicle deflector of claim 3 wherein one or more accessories is mounted to the mounting bar.

6. The vehicle deflector of claim 5 wherein the one or more accessories is a cup holder.

7. The vehicle deflector of claim 1 wherein the material chosen for the deflector is transparent.

8. The vehicle deflector of claim 1 wherein the vehicle deflector is attached to a vehicle by inserting the one or more hinge pins into vehicle door hinge halves mounted on a vehicle.
